(19) United States
(12) Patent Application Publication
(10) Pub. No.: US 2014/0355823 A1
(43) Pub. Date: Dec. 4, 2014

(54) VIDEO SEARCH APPARATUS AND METHOD

(71) Applicant: SAMSUNG SDS CO., LTD., Seoul (KR)

(72) Inventors: Ki Sang KWON, Seoul (KR); Jeong Seon LEE, Yongin-si (KR); Jun Hee HEU, Seoul (KR); Daeki CHO, Yongin-si (KR); Jin Uk KWAG, Seoul (KR)

(73) Assignee: SAMSUNG SDS CO., LTD., Seoul (KR)

(21) Appl. No.: 14/144,729

(22) Filed: Dec. 31, 2013

(30) Foreign Application Priority Data
May 31, 2013 (KR) 10-2013-0062237

(51) Int. Cl. G06K 9/00

(52) U.S. Cl. CPC G06K 9/00711; G06K 9/00771
USPC 382/103

(57) ABSTRACT

The present invention relates to a video search apparatus and method, and more particularly, to a video search apparatus and method which can be used to search video data collected by a video capture apparatus, such as a closed circuit television (CCTV), for information desired by a user.

This application claims priority from Korean Patent Application No. 10-2013-0062237 filed on Mar. 31, 2013 in the Korean Intellectual Property Office, the disclosure of which is incorporated herein by reference in its entirety.

### BACKGROUND OF THE INVENTION

1. Field of the Invention

The present invention relates to a video search apparatus and method, and more particularly, to a video search apparatus and method which can be used to search video data collected by a video capture apparatus, such as a closed circuit television (CCTV), for information desired by a user.

2. Description of the Related Art

To protect private and public properties, various forms of security systems and security devices have been developed and are in use. One of the most widely used security systems is a video security system using a device (such as a closed circuit television (CCTV)) that informs the occurrence of an intrusion. When an intrusion occurs, the video security system generates a signal indicating the occurrence of the intrusion and transmits the generated signal to a manager such as a house owner or a security company. Accordingly, the manager checks the signal.

When an unauthorized object such as a person passes a preset sensing line, a conventional video security system may sense the object passing the preset sensing line and inform a user of this event. Otherwise, the conventional video security system may search data captured and stored by a video capture apparatus such as a CCTV for information about the object that passed the preset sensing line.

However, while the conventional video security system can search for data corresponding to a preset event such as the passing of a preset sensing line, it cannot search for data corresponding to an event that was not preset. That is, the conventional video security system can search for data corresponding to events A, B and C that were set when data was collected and stored in the past. However, the conventional video security system cannot search for data corresponding to event D which was not set when the data was collected in the past.

### SUMMARY OF THE INVENTION

Aspects of the present invention provide a video search apparatus and method which can be used to search for data corresponding to an event that was not set when a video capture apparatus collected data.

Aspects of the present invention also provide a video search apparatus and method which enable a user to visually easily set an event query through a user interface.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a video search apparatus including: an input unit receiving event setting information which indicates one or more conditions constituting an event to be searched for in a video captured by a video capture apparatus; and a search unit searching metadata about each object included in the video for data that matches the event by using the event setting information.

According to another aspect of the present invention, there is provided a video search method including: receiving event setting information which indicates one or more conditions constituting an event to be searched for in a video captured by a video capture apparatus; and searching metadata about each object included in the video for data that matches the event by using the event setting information.

In the first aspect of the present invention, there is provided A video search apparatus, the apparatus comprising: an input unit receiving event setting information which indicates one or more conditions constituting an event to be searched for in a video captured by a video capture apparatus; an event query generation unit generating an event query, which corresponds to the event, using the event setting information; and a search unit searching metadata about each object included in the video for data that matches the event query, wherein the metadata searched by the search unit is metadata stored before the event setting information is input.

In the first aspect of the present invention, there is provided A video search method, the method comprising: receiving event setting information which indicates one or more conditions constituting an event to be searched for in a video captured by a video capture apparatus; generating an event query, which corresponds to the event, using the event setting information; and searching metadata about each object included in the video for data that matches the event query by using the event setting information, wherein the metadata searched in the searching of the metadata is metadata stored before the event setting information is input.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram illustrating the configuration of a video search system according to an embodiment of the present invention;

FIG. 2 is a block diagram of a video search apparatus according to an embodiment of the present invention;

FIG. 3 is a block diagram of an example of an input unit included in the video search apparatus of FIG. 2;

FIGS. 4 through 6 are diagrams illustrating examples of inputting event setting information and generating an event query corresponding to the event setting information;

FIG. 7 is a diagram illustrating an object input unit included in the video search apparatus of FIG. 2;

FIG. 8 is a diagram illustrating an example of inputting object setting information by selecting an object;

FIG. 9 is a diagram illustrating an example of providing search results using a provision unit;

FIG. 10 is a flowchart illustrating a video search method according to an embodiment of the present invention; and

FIG. 11 is a flowchart illustrating a video search method according to another embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

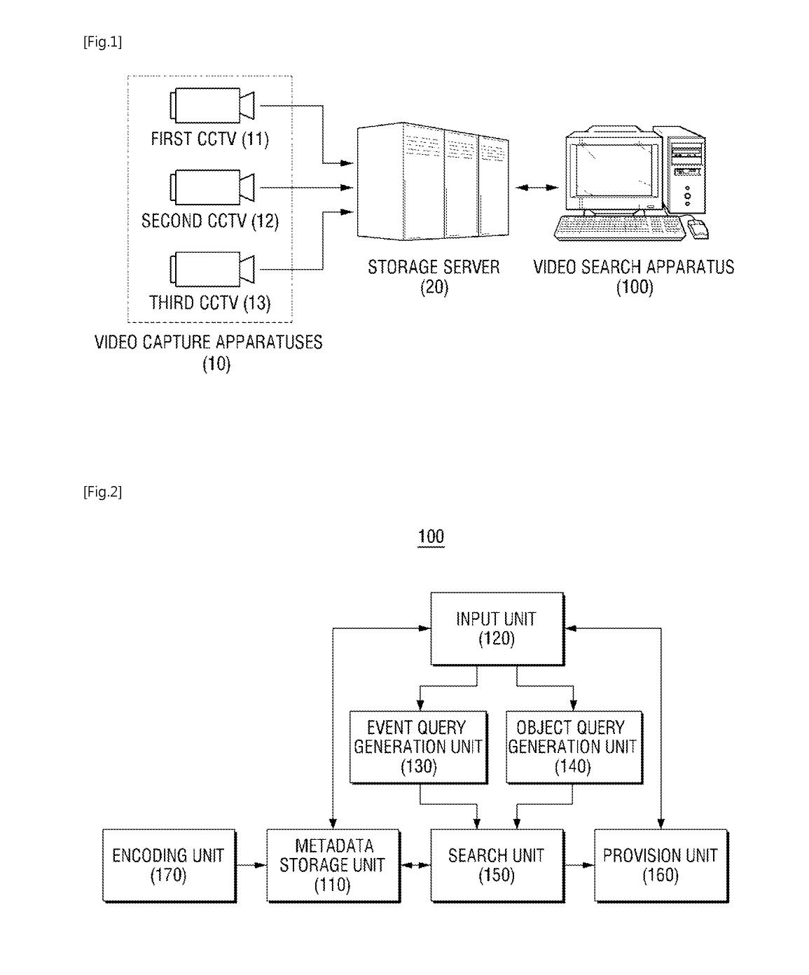

FIG. 1 is a diagram illustrating the configuration of a video search system according to an embodiment of the present invention.

Referring to FIG. 1, the video search system according to the current embodiment includes video capture apparatuses 10, a storage server 20, and a video search apparatus 100.

The video capture apparatuses 10 include one or more video capture apparatuses Like a closed circuit television (CCTV), each of the video capture apparatuses 10 captures a video of its surroundings and transmits the captured video to the storage server 20 in a wired or wireless manner or store the captured video in a memory chip, a tape, etc.

The storage server 20 stores video data captured by each of the video capture apparatuses 10.

The video search apparatus 100 receives event setting information from a user who intends to search video data stored in the storage server 20 for desired information, generates an event query using the event setting information, searches the video data stored in the storage server 20 for data that matches the generated event query, and provides the found data.

The storage server 20 can be included in the video search apparatus 100. A metadata storage unit 110 (which will be described later) that stores metadata can be included in the video search apparatus 100 or in a server (e.g., the storage server 20) separate from the video search apparatus 100.

The video search system according to the current embodiment may set an event not preset by a user and search video data stored in the storage server 20 for data that matches the set event. That is, unlike conventional technologies, the video search system according to the current embodiment can search the stored video data for desired data based on an event that is set after the video data is stored according to the needs of the user.

For example, the current time may be Jan. 1, 2013, and a user may want to obtain videos of people who intruded into area A from Jan. 1, 2012 to Dec. 31, 2012. In this case, there should be a sensing line set in area A before Jan. 1, 2012. Only then can a conventional video security system store videos of people who passed the set sensing line separately from other videos or store the videos in such a way that the videos can be searched using a preset query.

If there is no sensing line set in area A before Jan. 1, 2012, the conventional video security system has to search for people who intruded into area A by checking every video captured of area A from Jan. 1, 2012 to Dec. 31, 2012.

On the other hand, the video search system according to the current embodiment can search for people who intruded into area A from Jan. 1, 2012 to Dec. 31, 2012 by setting a sensing line in area A at the current time of Jan. 1, 2013 and obtain videos captured of the people.

The term ‘event,’ as used herein, may encompass a sensing line event that detects an intrusion using a sensing line, a burglary surveillance event, a neglected object surveillance event, a wandering surveillance event, various events used in a video surveillance system, and events that can be arbitrarily set by a user.

A video search apparatus according to an embodiment of the present invention will now be described in detail with reference to FIG. 2.

FIG. 2 is a block diagram of a video search apparatus 100 according to an embodiment of the present invention.

Referring to FIG. 2, the video search apparatus 100 according to the current embodiment may include a metadata storage unit 110, an input unit 120, an event query generation unit 130, an object query generation unit 140, a search unit 150, a provision unit 160, and an encoding unit 170.

The metadata storage unit 110 may store metadata of each object included in video data captured by video recording apparatuses. When necessary, the metadata storage unit 110 may store data captured by the video recording apparatuses as metadata of each event or frame.

Objects in video data may include various forms of objects constituting a video and extracted through the analysis of the video, such as a moving object (e.g., a person), an object moving with a person (e.g., a hat or sunglasses a person is wearing), an object that is being moved or can be moved, etc.

To store metadata of each object in the metadata storage unit 110, the video search apparatus 100 according to the current embodiment may include, if necessary, the encoding unit 170 which converts video data captured by the video recording apparatuses into metadata of each object. The encoding unit 170 may convert captured video data into metadata of each object by encoding the video data in an object-oriented video format such as Moving Picture Experts Group 4 (MPEG 4).

In addition, the encoding unit 170 may set coordinates indicating each location in each frame of a captured video, obtain coordinate information of each object in each frame of the video, and convert the coordinate information of each object into metadata about the coordinate information of each object.

The encoding unit 170 may also obtain color information of each object in each frame of the captured video and convert the color information of each object into metadata about the color information of each object.

The encoding unit 170 may also obtain feature point information of each object in each frame of the captured video and convert the feature point information of each object into metadata about the feature point information of each object.

The input unit 120 may receive event setting information from a user. The event setting information is information indicating one or more conditions that constitute an event to be searched for in a video captured by a video capture apparatus. The input unit 120 may also receive object setting information from the user. The object setting information is information indicating one or more conditions that constitute an object to be searched for in the video captured by the video capture apparatus.

That is, the user may input the event setting information and/or the object setting information through the input unit 120.

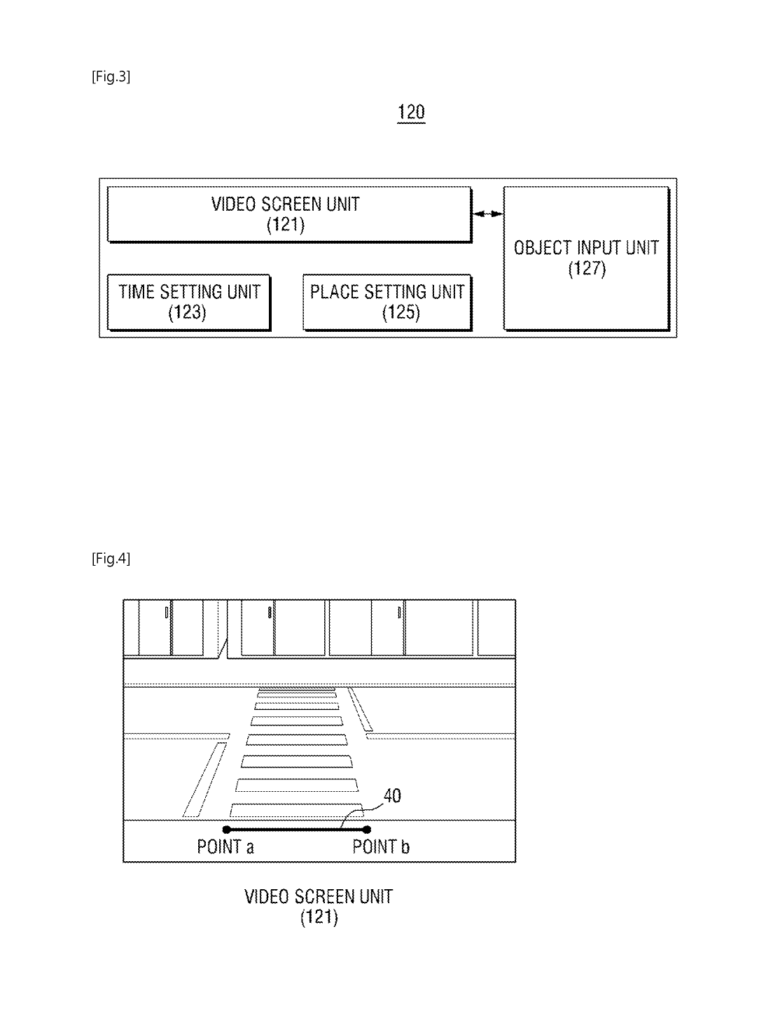

The input unit 120 will now be described in detail with reference to FIG. 3.

FIG. 3 is a block diagram of the input unit 120 included in the video search apparatus 100 of FIG. 2. n

Referring to FIG. 3, the input unit 120 may include a video screen unit 121, a time setting unit 123, a place setting unit 125, and an object input unit 127.

The time setting unit 123 may select a capture time desired by a user. When the user does not select a capture time, the time setting unit 123 may set all videos captured at all times as videos to be searched without limiting the time range. Alternatively, when the user does not select a capture time range, the time setting unit 123 may automatically set the time range to a preset time range (e.g., from 20 years ago to the present time).

The place setting unit 125 may set a place desired by a user. That is, the place setting unit 125 may set a video capture apparatus that captures a place desired by the user. When the user does not set a place range, the place setting unit 125 may set videos captured by all video capture apparatuses connected to the storage server 20 as videos to be searched without limiting the place range.

To help a user set a desired time range and a desired place range, the video screen unit 121 may provide a visual user interface. When the user inputs a time range and a place range through the user interface, the time setting unit 12 and the place setting unit 125 may respectively set a time range and a place range corresponding to the user's input.

The video screen unit 121 provides the visual user interface to a user. The video screen unit 121 includes an input device such as a touchscreen. The user can input desired event setting information by, e.g., touching the user interface. The video screen unit 121 visually and/or acoustically provides part of a video stored in the storage server 20 or a captured screen at the request of the user or according to a preset bar, thereby helping the user easily input event setting information.

The user may input event setting information by selecting at least one of preset items provided on the user interface. Alternatively, the user may input the event setting information by using text information. Alternatively, the user may input the event setting information by selecting, dragging, etc. a specific area in an image provided by the video screen unit 121.

Referring back to FIG. 2, the event query generation unit 130 may generate an event query using event setting information input through the user interface provided by the video screen unit 121. The event query is a query used to search for objects corresponding to an event.

The event query generation unit 130 may generate an event query, which corresponds to event setting information input by a user through the user interface, according to a preset bar. The event query generation unit 130 generates an event query using event setting information received from the input unit 120.

That is, the event query generation unit 130 may generate an event query, which corresponds to the user's input, according to a preset bar. For example, if the user drags from point a to point b, the event query generation unit 130 may generate a sensing line event query from point a to point b, such that the search unit 150 searches for data including objects that passed through the sensing line.

Examples of inputting event setting information and generating an event query corresponding to the event setting information will now be described in detail with reference to FIGS. 4 through 6.

Referring to FIG. 4, at the request of a user, the video screen unit 121 is providing a still image captured at a specific time. The still image provided by the video screen unit 121 may be a still image captured at the specific time among videos captured by the image capture apparatuses 10. When intending to search for data including objects that crossed a crosswalk, the user may input event setting information by dragging along an end of the crosswalk. Based on the user's drag touch input, the event query generation unit 130 may generate a sensing line event query that can be used to search for objects that crossed the end of the crosswalk as shown in FIG. 4.

Specifically, the user may input sensing line event setting information by dragging from point a to point b in the still image provided by the video screen unit 121. Then, the event query generation unit 130 may generate a sensing line event query from point a to point b based on the input sensing line event setting information.

Referring to FIG. 5, when inputting the sensing line event setting information, the user may input additional information such as a direction 42 in which objects pass a sensing line and a speed range 41 in which the objects pass the sensing line. For example, an event query may be set such that objects that passed the sensing line in the speed range 41 of 10 km/h or more and in the direction 42 from bottom to top of the screen (an y-axis direction) are searched for. To generate such a sensing line event query, the user may input sensing line event setting information by adjusting the size of a drag input, drag speed, etc. or by providing additional inputs through the user interface. Then, by using the input sensing line event setting information, the event query generation unit 130 may generate a sensing line event query including the intrusion direction of objects and the speed range of the objects at the time of intrusion. For example, the size of a drag input may set the speed range 42 of objects passing the sensing line.

In the above example, when the user drags from point a to point b in the still image provided by the video screen unit 121, a sensing line event query is generated. However, the user's drag input does not necessarily lead to the generation of the sensing line event query. Other forms of input may also lead to the generation of the sensing line event query. Conversely, the drag input may lead to the generation of other types of event query.

Two or more sensing line event queries can be generated. In addition, a specific area can be set as a sensing line event query. To input two or more pieces of sensing line event setting information, the user may conduct two or more dragging actions on the video screen unit 121. Alternatively, the user may set a specific area as a sensing line through, e.g., a multi-touch on a quadrangular shape provided on the user interface of the video screen unit 121. Alternatively, the user may drag in the form of a closed circuit, so that the event query generation unit 130 can set an event query used to search for objects existing in a specific area.

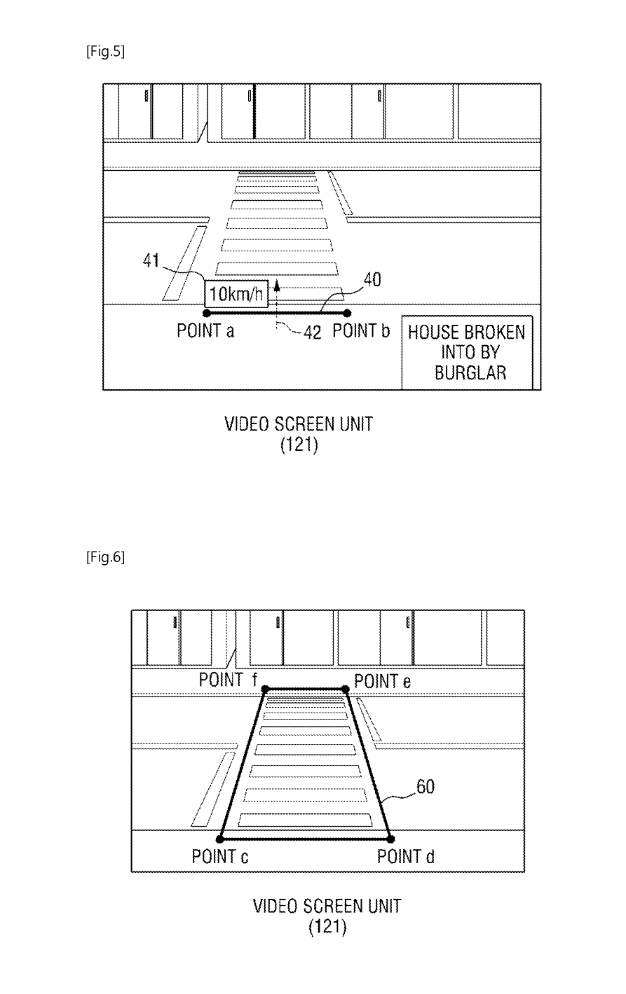

Referring to FIG. 6, the user may drag from point c through points d, e and f and back to point c, thereby setting a search area 60 as shown in FIG. 6. Alternatively, the user may set the search area 60 as shown in FIG. 6 through a multi-touch on a quadrangular shape provided on the user interface. The event query generation unit 130 may generate an event query that can be used to search for objects that intruded into the search area 60. Alternatively, the event query generation unit 130 may generate an event query according to the user's input, system set-up, etc. When the user's input is as shown in FIG. 6, the event query generation unit 130 may set the search area 60 using the user's input and generate an event query such that objects that existed in the set search area 60 or objects that existed only in the search area 60 can be searched for. When an input that sets the search area 60 as shown in FIG. 6 is received, the video screen unit 121 may pop up a message requiring the selection of an event query to be generated in order to identify the user's intention more accurately.

The user may input not only event setting information but also object setting information through the video screen unit 121.

Specifically, the user may input object setting information through the video screen unit 121 as follows. When the video screen unit 121 provides, at the request of the user, a still image captured at a specific time, the user may select a specific object existing in the still image or input an image file of an object to be searched for through the user interface provided by the video screen unit 121. The user may also input text through the user interface.

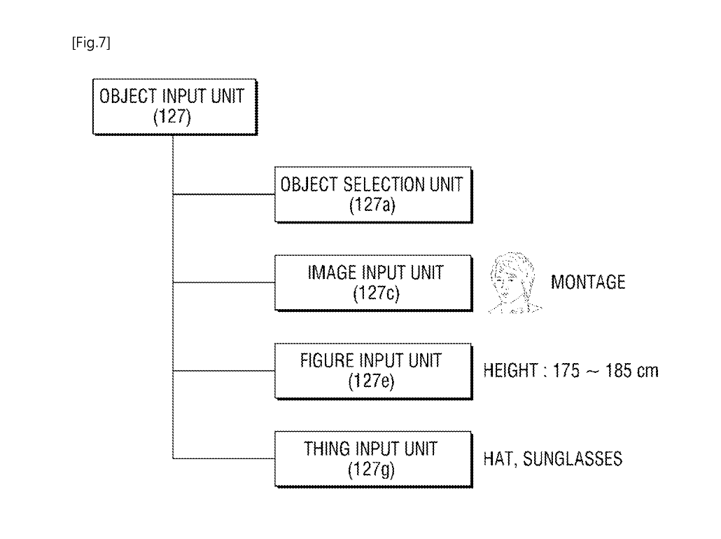

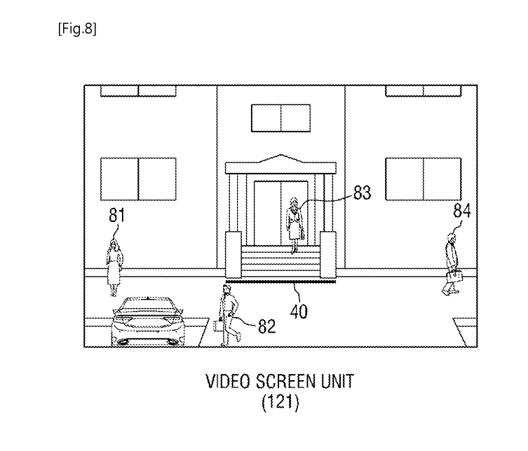

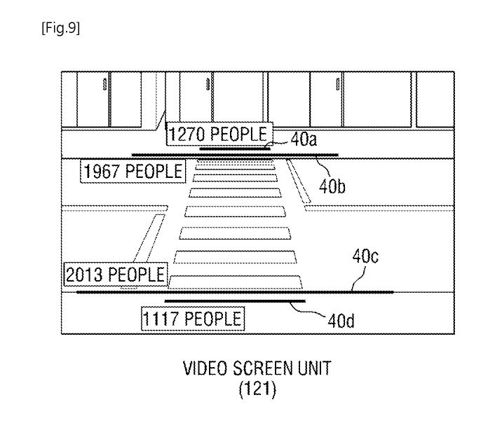

Specifically, referring to FIG. 7, the object input unit 127 may include an object selection unit 127a, an image input unit 127c, a figure input unit 127e, and a thing input unit 127g.

The object selection unit 127a is used by a user to input object setting information by selecting an object through, for example, a touch on an image provided by the video screen unit 121. The image input unit 127c is used by the user to input object setting information by inputting an external image such as a montage image. The figure input unit 127e is used by the user to input a figure range through the user interface. The thing input unit 127g is used by the user to input the name of a thing through the user interface. In addition, the object input unit 127 may receive various information (such as size, shape, color, traveling direction, speed and type) about an object from the user.

A specific example of inputting object setting information by selecting an object will now be described with reference to FIG. 8.

For example, if a burglar broke into a house at a K apartment at about 17:00 p.m. on Dec. 31, 2012, a user (e.g., the police) may set a first CCTV 11 which captures the entrance of the K apartment as a search place by using the place setting unit 125. In addition, the user may set data captured from 13:00 p.m. on Dec. 31, 2012 to 19:00 p.m. on Dec. 31, 2012 by the first CCTV 11 as a search range by using the time setting unit 123. Additionally, the user may set a sensing line 40 by dragging along the entrance. The user may also input only humans as object setting information.

Based on the above set information, the search unit 150 may search the data captured by the first CCTV 11 from 13:00 p.m. on Dec. 31, 2012 to 19:00 p.m. on Dec. 31, 2012 for metadata about people who passed the set sensing line 40.

The provision unit 160 may provide the people included in the metadata found by the search unit 150 to the user through the video screen unit 121. When there is no captured image (e.g., in the storage server 20) in which all of the people included in the found metadata appear simultaneously, the provision unit 160 may provide information edited to include all of the people on the screen provided to the user. For example, the provision unit 160 may provide found people 81 through 84 on one screen as shown in FIG. 8. Alternatively, the provision unit 160 may provide an image (or video) of the people 81 through 84 only without a background image such as a vehicle at the K apartment.

The user may select one or more suspects from the people 81 through 84 provided by the provision unit 160 by, e.g., touching them. When the user selects a person, the object input unit 127 may receive the selected person (object) as object setting information, and the object query generation unit 140 may generate an object query using the object setting information such that data including the same or similar person to the person selected by the user is searched for. Then, the search unit 150 may search for metadata including the same or similar person to the person selected by the user based on the setting of the object query generated by the object query generation unit 140.

Referring back to FIG. 2, the object query generation unit 140 may generate an object query using object setting information received from the input unit 120. The object query may be a query about conditions of an object to be searched for in data or may be a query about an object to be searched for by the user.

Specifically, the user may input object setting information by selecting an object, inputting an image, inputting figures, inputting a thing, etc. through the input unit 120. Then, the object query generation unit 140 may generate an object query corresponding to the object setting information input by the user. Referring to FIG. 7, when the input unit 120 receives a vehicle selected as an object, the object query generation unit 140 may generate a query that can be used to search for data including the same object as the input vehicle. Alternatively, when the input unit 120 receives a montage image, the object query generation unit 140 may generate an object query that can be used to search for data including objects having the same or similar feature points to those of the input montage image. Alternatively, when the input unit 120 receives people with a height of 175 to 185 cm as object setting information, the object query generation unit 140 may generate an object query that can be used to search for data including people with a height of 175 to 185 cm. When the input unit 120 receives people wearing sunglasses or a hat as object setting information, the object query generation unit 140 may generate an object query that can be used to search for data including people wearing sunglasses or a hat. An object query correspond to object setting information input by the user may vary according to the type of user interface, user setting, design environment, etc.

The search unit 150 may search metadata stored in the metadata storage unit 110 for data that matches event setting information and object setting information. Specifically, the search unit 150 may search the metadata stored in the metadata storage unit 110 for data that matches an event query and an object query.

The metadata searched by the search unit 150 may include metadata collected and stored before event setting information is input. Alternatively, the metadata searched by the search unit 150 may only include metadata collected and stored before the event setting information is input.

When a time and a place are set, the search unit 150 may search metadata corresponding to the set time and the set place.

Specifically, the search unit 150 may search the metadata stored in the metadata storage unit 110 for metadata Data a including objects that match a generated object query. Then, the search unit 150 may search the found metadata Data a for metadata Data b including objects that match a generated event query. According to the type of event query or in some cases, the search unit 150 may search for metadata Data c that matches a generated event query and then search the found metadata Data c for metadata Data d including objects that match a generated object query.

The metadata stored in the metadata storage unit 110 may include information about each object included in video data captured by the video capture apparatuses 10. Thus, the search unit 150 can search for data that matches both an object query and an event query.

The order in which the search unit 150 searches for data using an object query and an event query may be determined by search accuracy, search logicality, the intention of the user, search speed, etc. That is, the search unit 150 may search the metadata stored in the metadata storage unit 110 using an object query first and then search found metadata, which corresponds to the object query, using an event query. Conversely, the search unit 150 may search the metadata stored in the metadata storage unit 110 using an event query first and then search found metadata, which corresponds to the event query, using an object query.

When the input unit 120 inputs a plurality of pieces of event setting information, the event query generation unit 130 may generate a plurality of event queries. Likewise, when the input unit 120 inputs a plurality of pieces of object setting information, the object query generation unit 140 may generate a plurality of object queries. When a plurality of event queries are generated, the search unit 150 may search for metadata including objects that satisfy all of the event queries or metadata including objects that satisfy at least one of the event queries according to the intention of the user. Alternatively, the search unit 150 may search for objects that satisfy a predetermined number of event queries among the event queries. The search operation of the search unit 150 applies the same to a case where a plurality of object queries are set.

The search unit 150 may also perform an expanded search. The expanded search is to search for new data based on search results of the search unit 150. The expanded search may be performed two or more times.

For example, if the search unit 150 finds data including a person (object) who is wearing a hat and passes a sensing line according to the user's input, it may search data captured by CCTVs around a set CCTV at similar times to a set time condition for data including the same person (object). Also, the search unit 150 may provide all event information generated by the object or search for the movement of the object. This expanded search may be performed only when the user desires. When the user inputs object information or event information through the input unit 120 based on the found information, the search unit 150 may search for new information. The video screen unit 121 may provide various search options including an option for the above example of expanded search based on found information, thereby promoting the convenience of selection of the user and the ease of search.

The provision unit 160 may visually provide search results of the search unit 150 to the user.

The provision unit 160 may provide a captured video including metadata that corresponds to the search results of the search unit 150. Alternatively, the provision unit 160 may list the search results of the search unit 150 in the form of texts or images.

A captured video provided by the provision unit 160 may be a video stored in the storage server 20.

When the provision unit 160 is unable to provide a captured video including metadata that corresponds to the search results, it may provide information about a location at which the captured video including the metadata that corresponds to the search results is stored. The provision unit 160 may also provide data corresponding to the search results as much as the user desires and in the form of level of detail (LOD).

When the search unit 150 provides the result of searching for objects that satisfy at least one of a plurality of set event queries, the provision unit 160 may provide the number of event queries that each object included in the search result satisfies.

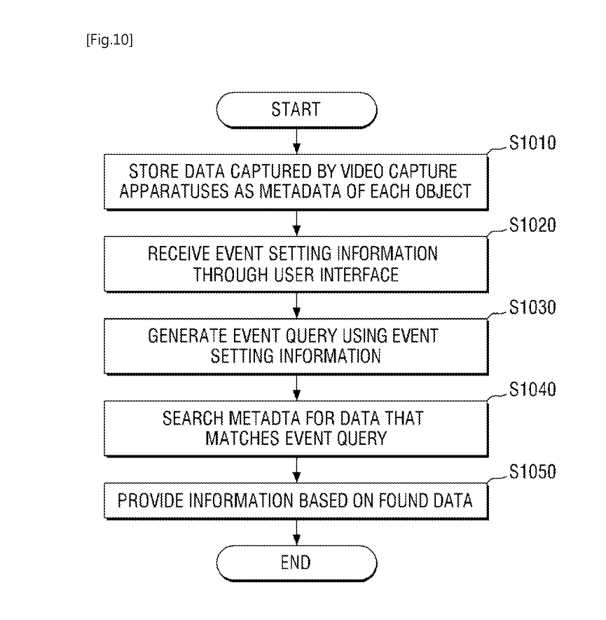

Referring to FIG. 9, when a user inputs event setting information (for generating an event query) through the video screen unit 121 (which generates an event query), the provision unit 160 may numerically provide search results corresponding to a generated event query. That is, when a sensing line event query is set by the user's drag input, the search unit 150 my search for objects that match the set sensing line event query and display the search results near the set sensing line. The displayed search results can be easily used to analyze various statistics.

For example, sensing lines 40a and 40d can be guessed based on statistics including objects such as people who used a crosswalk normally. In addition, sensing lines 40b and 40c can be guessed based on statistics including objects such as people who used the crosswalk abnormally, for example, people who walked diagonally across the crosswalk or crossed the road near the crosswalk. In FIG. 9, the number of objects (people) that passed the sensing line 40a is 1,270, the number of objects that passed the sensing line 40d is 1,117, the number of objects that passed the sensing line 40b is 1,967, and the number of objects that passed the sensing line 40c is 2,013. Therefore, it can be guessed that the number of objects that used the crosswalk abnormally is far greater than the number of objects that used the crosswalk normally. These statistics may be compared and analyzed for use in various fields.

As described above, the conventional art can obtain information about an event only when the event is set in advance. On the other hand, even if a user inputs event setting information after data is collected, the present invention can obtain various information using the event setting information. In addition, it is easy to obtain information from big data and obtain information in various event situations.

Furthermore, the present invention cannot only search for objects that generated a preset event but also set an event after data is stored and then search for objects that generated the set event. Therefore, the present invention includes the ability to search for objects that generated a preset event.

FIG. 10 is a flowchart illustrating a video search method according to an embodiment of the present invention.

Referring to FIG. 10, the metadata storage unit 110 stores metadata of each object included in video data captured by the video capture apparatuses 10 (operation S1010).

The input unit 120 may receive event setting information, which indicates one or more conditions constituting an event to be searched for in videos captured by the video capture apparatuses 10, from a user through a visual user interface (operation S1020).

The event query generation unit 130 may generate an event query using the event setting information (operation S1030).

The search unit 150 may search the metadata stored in the metadata storage unit 110 for data that matches the set event query (operation S1040).

The provision unit 160 may provide various forms of information to the user based on the data found by the search unit 150 (operation S1050).

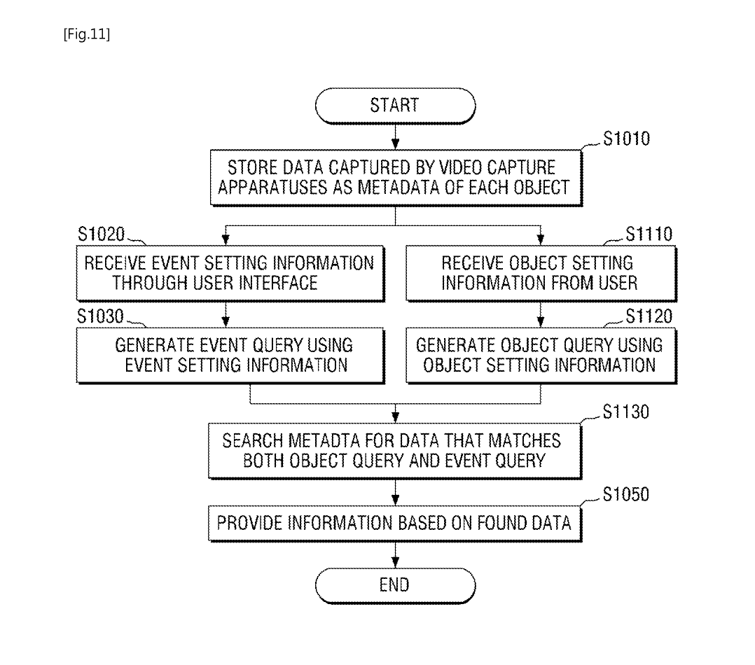

FIG. 11 is a flowchart illustrating a video search method according to another embodiment of the present invention.

Referring to FIG. 11, the input unit 120 may receive object setting information, which indicates one or more conditions constituting an object to be searched for in videos captured by the video capture apparatuses 10, from a user (operation S1110).

The object query generation unit 140 may generate an object query using the object setting information received by the input unit 120 (operation S1120).

The search unit 150 may search metadata for data that matches both the object query and an event query (operation S1130). The search unit 150 may perform an expanded search based on the data found by the search unit 150. The provision unit 160 may provide various information based on the data found by the search unit 150 (operation S1050).

The present invention can generate an event query at a time desired by a user and search video data collected before the generation of the event query for data that matches the generated event query.

In addition, the present invention can easily set an event through a visual and intuitive user interface.

The present invention can also easily obtain information desired by the user from big data.

Furthermore, the present invention can analyze metadata on an object-by-object basis and on a frame-by-frame basis. Therefore, it is possible to improve data analysis by reducing errors that occur in real-time analysis and improve the accuracy of event search.

Last but not least, the present invention can obtain necessary information from videos captured and stored by various CCTVs, and the obtained information can be easily used in various fields including security, object tracking and statistics.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A video search apparatus comprising:
an input unit configured to receive event setting information indicating one or more conditions defining an event to be searched for in a video;
an event query generation unit configured to generate an event query, corresponding to the event, using the event setting information; and
a search unit configured to search metadata, about each object of a plurality of objects included in the video, for data that matches the event query;
wherein the metadata searched by the search unit is stored before the input unit receives the event setting information.

2. The video search apparatus of claim 1, further comprising:
an encoding unit configured to receive the video and to generate the metadata from the received video; and
a metadata storage unit configured to store the metadata.

3. The video search apparatus of claim 2, wherein the encoding unit is further configured to:
set coordinates indicating each location in each frame of the video,
obtain coordinate information for each object of the plurality of objects included in each frame of the video, and
generate the metadata based on the coordinate information.

4. The video search apparatus of claim 2, wherein the encoding unit is further configured to:
obtain color information of each object of the plurality of objects included in each frame of the video, and
generate the metadata based on the color information.

5. The video search apparatus of claim 2, wherein the encoding unit is further configured to:
obtain feature point information of each object of the plurality of objects included in each frame of the video, and
generate the metadata based on the feature point information.

6. The video search apparatus of claim 1, further comprising a visually displayed user interface, wherein the input unit is further configured to receive the event setting information through the user interface.

7. The video search apparatus of claim 6, wherein:
the user interface is further configured to detect a drag input when a user drags between specific locations on the user interface,
the input unit is further configured to receive the drag input,
the event query generation unit is further configured to generate the event query as a sensing line event query based on the received drag input, and
the search unit is further configured to respond to the sensing line event query by searching the metadata for objects that match the sensing line event query.

8. The video search apparatus of claim 6, wherein:
the user interface is further configured to detect when a user designates a specific area through the user interface,
the input unit is further configured to receives information about the specific area,
the event query generation unit is further configured to generate the event query as an area event query based on the information about the specific area, and
the search unit is further configured to respond to the area event query by searching the metadata for data about objects existing in the specific area in accordance with the area event query.

9. The video search apparatus of claim 1, further comprising a provision unit configured to provide a captured video which contains data found by the search unit or information about the captured video.

10. The video search apparatus of claim 1, further comprising an object query generation unit, wherein:
the input unit is further configured to receive object setting information indicating one or more conditions defining a search object;
the object query generation unit is configured to generate an object query, corresponding to the search object, based on the object setting information; and
the search unit is further configured to search the metadata for data that matches the object query and the event query.

11. The video search apparatus of claim 10, further comprising a provision unit;
wherein:
the event query generation unit is further configured to generate a plurality of event queries,
the search unit is further configured to search ones of the plurality of objects, that match the object query, for a subset of the objects that also match at least one of the plurality of event queries, and
the provision unit is configured to display the number of event queries having matches among the subset of the objects.

12. The video search apparatus of claim 11, wherein:
the input unit is further configured to receive an image file of an object,
the object query generation unit is further configured to generate the object query using feature points of the object in the image file, and
the search unit is further configured to search the metadata for data that matches the object query and at least one of the plurality of event queries.

13. The video search apparatus of claim 10, wherein:
the input unit is further configured to receive a vehicle number,
the object query generation unit is further configured to generate the object query based on the vehicle number, and
the search unit is further configured to search the metadata for data matching the object query and the event query.

14. A video search method comprising:
receiving event setting information indicating one or more conditions defining an event to be searched for in a video;
generating an event query, corresponding to the event, using the event setting information;
searching metadata, about each object in the video, for data matching the event query; and
before the receiving of the event setting information, storing the metadata.

15. The video search method of claim 14, further comprising:
receiving the video;
generating the metadata about each object in the video; and
storing the metadata in a storage.

16. The video search method of claim 15, wherein the generating of the metadata includes:
setting coordinates indicating each location in each frame of the video,
obtaining coordinate information of each object in each frame of the video, and
generating the metadata based on the coordinate information.

17. The video search method of claim 15, wherein the generating of the metadata further comprises:
obtaining color information of each object in each frame of the video; and
generating the metadata based on the color information.

18. The video search method of claim 15, wherein the generating of the metadata further comprises:
obtaining feature point information of each object in each frame of the video, and
generating the metadata based on the feature point information.

19. The video search method of claim 14, further comprising using a displayed visual user interface for the receiving of the event setting information.

20. The video search method of claim 19, further comprising:
detecting when a user drags between specific locations on the user interface,
receiving the drag input as part of the receiving of the event setting information,
setting, as the event query, an area event query based on the information about the specific area, and
searching the metadata to find data about objects in the specific area in accordance with the area event query.
